(19) United States
(12) Patent Application Publication
(10) Pub. No.: US 2022/0288596 A1
(43) Pub. Date: Sep. 15, 2022

(54) TUBE FRAME APPARATUS, TUBE FRAME ASSEMBLIES, AND METHODS OF HOLDING TUBES

(71) Applicant: Siemens Healthcare Diagnostics Inc., Tarrytown, NY (US)

(72) Inventors: James Grayson, Walnut Creek, CA (US); Raymond Mei, Castro Valley, CA (US); Philip Chia, El Cerrito, CA (US); Don Collado, Vallejo, CA (US)

(73) Assignee: Siemens Healthcare Diagnostics Inc., Tarrytown, NY (US)

(21) Appl. No.: 17/755,849

(22) PCT Filed: Nov. 11, 2020
(86) PCT No.: PCT/US2020/059928

§ 371 Date: May 10, 2022

Related U.S. Application Data
(60) Provisional application No. 62/948,359, filed on Dec. 16, 2019.

(51) Int. Cl. B01L 9/00; B01L 3/00

(52) U.S. Cl. CPC B01L 9/523; B01L 3/50855; B01L 2200/025; B01L 2300/042

(57) ABSTRACT

A tube frame apparatus is disclosed. In one aspect, the tube frame apparatus has a body having a top surface and a plurality of apertures formed in rows therein, the apertures configured to receive strips of tubes, and locking tabs projecting from the top surface that are configured to engage with the strips of tubes. Flanges of the tubes, or optionally connector strips between the tubes, can be engaged by the locking tabs. Tube frame assemblies and methods of holding strips of tubes in tube frame apparatus are provided, as are other aspects.

### FIELD

The present disclosure relates to tube frame apparatus adapted to hold sample tubes therein.

### BACKGROUND

Testing within diagnostic laboratories, for example, may involve measuring one or more constituents in a biological sample obtained from a patient, such as in whole blood, blood serum, blood plasma, cerebral-spinal fluid, interstitial fluid, urine, and the like. Automated immunoassay instruments may be used to reduce the number of trained technicians required to perform analyses, improve overall accuracy, and reduce the cost per operation performed.

PCR testing, in particular, is a technique used to amplify a targeted DNA sequence from just a few samples to billions of copies within a short period of time. For example, PCR testing can be used for identification of DNA sequences involved in cancer or genetic disorders, such as cystic fibrosis, or for the identification and diagnosis of diseases caused by fungi, bacteria, and viruses, for example.

In such PCR. testing, cycles of denaturing and synthesizing new DNA are repeated as many times, leading to a large number of (e.g., more than one billion in some cases) exact copies of the original DNA segment. In PCR testing, such biological samples and other test liquids (e.g., reagents, etc.) are provided in tubes 104 that can be arranged in a tube frame. In some embodiments, the tubes 104 may be included as part of a strip of tubes 102, such as is shown in FIGS. 1A-1E. The strip of tubes 102 is made up of a plurality of the tubes 104 (e.g., eight tubes 104 are shown) connected together by a series of connector strips 106. Tubes 104 and connector strips 106 may be molded clear polypropylene. The tubes 104 of the strip of tubes 102 are configured to reside in apertures of the tube frame and can include a flange 108 that can rest in a conical region of the apertures of the tube frame. The tops of the plurality of the tubes 104 of the strip of tubes 102 can be sealed with a sealing strip 110, as shown in FIG. 1C, that includes a plurality of interconnected caps 112 that are inserted in the tops of the tubes 104 to seal the tubes 104. Caps 112 may also be made from polypropylene.

### SUMMARY

According to a first aspect, a tube frame apparatus is provided. The tube frame apparatus includes a body having a top surface and a plurality of apertures formed in rows therein, the apertures configured to receive strips of tubes, and locking tabs projecting from the top surface that are configured to engage with the strips of tubes.

According to another aspect, a sample tube frame assembly is provided. The sample tube frame assembly includes a tube frame adapter including a top registration feature, and a tube frame apparatus having a body including a bottom registration feature registered on the top registration feature, the body further including a top surface and a plurality of apertures formed in rows, the apertures configured to receive strips of tubes therein, and locking tabs projecting from the top surface that are configured to engage with the strips of tubes.

In another aspect, a method of holding a strip of sample tubes in a tube frame is provided. The method includes providing a tube frame apparatus comprising a body having a top surface and a plurality of apertures formed in rows, and locking tabs projecting from the top surface, and inserting the tubes of the strip of tubes into the apertures and retaining the strip of tubes with the locking tabs.

Still other aspects, features, and advantages of the present disclosure may be readily apparent from the following detailed description by illustrating a number of example embodiments and implementations. The present invention may also be capable of other and different embodiments, and its several details may be modified in various respects. The disclosure is to cover all modifications, equivalents, and alternatives falling within the scope of the claims.

### BRIEF DESCRIPTION OF THE DRAWINGS

The disclosure will be better understood by referring to the detailed description taken in conjunction with the following drawings. The drawings and descriptions are to be regarded as illustrative in nature, and not as restrictive. The drawings are not necessarily drawn to scale. Like numerals are used throughout to denote like elements.

FIG. 1A illustrates a side plan view of a strip of tubes including tubes interconnected by connector strips according to the prior art.

FIG. 1B illustrates a top view of a strip of tubes according to the prior art.

FIG. 1C illustrates a side plan view of a sealing strip including interconnected caps configured to seal tubes of the strip of tubes according to the prior art.

FIG. 1D illustrates a perspective top view of a strip of tubes according to the prior art.

FIG. 1E illustrates a cross-sectioned side view of a strip of tubes taken along section line 1E-1E of FIG. 1D according to the prior art.

FIG. 2A illustrates a perspective view of a tube frame apparatus according to one or more embodiments of the disclosure.

FIG. 2B illustrates a top plan view of a tube frame apparatus according to one or more embodiments of the disclosure.

FIG. 2C illustrates a cross-sectioned side view of the tube frame apparatus taken along section line 2C-2C of FIG. 2B, but further including the strip of tubes inserted into the apertures of the tube frame apparatus according to one or more embodiments of the disclosure.

FIG. 2D illustrates a bottom plan view of a tube frame apparatus according to one or more embodiments of the disclosure.

FIG. 2E illustrates a partial top perspective view of a tube frame apparatus shown with a portion of a strip of tubes retained by locking tabs according to one or more embodiments of the disclosure.

FIG. 3 illustrates a cross-sectioned, partial side view of a tube frame apparatus including locking tabs retaining a tube of a strip of tubes in an aperture of the tube frame apparatus according to one or more embodiments of the disclosure.

FIG. 4A illustrates a partial, top plan view of an alternative tube frame apparatus including locking tabs retaining tubes of a strip of tubes in apertures of the tube frame apparatus, wherein the locking tabs interface with connector strips of the strip of tubes according to one or more embodiments of the disclosure.

FIG. 4B illustrates a partial, cross-sectioned side view of a tube frame apparatus showing locking tabs interfacing with connector strips of the strip of tubes according to one or more embodiments of the disclosure.

FIG. 5A illustrates a top perspective view of a tube frame adapter configured to engage with an underside surface of a tube frame apparatus according to one or more embodiments of the disclosure.

FIG. 5B illustrates a bottom perspective view of a tube frame adapter according to one or more embodiments of the disclosure.

FIG. 6 illustrates a top perspective view of a tube frame assembly including a tube frame apparatus coupled to a top of the tube frame adapter according to one or more embodiments of the disclosure.

FIG. 7 is a flowchart illustrating a method of holding a strip of sample tubes according to embodiments of the disclosure.

### DETAILED DESCRIPTION

In some instances, tubes 104 of the strip of tubes 102 can become displaced from the tube frame and that can cause potential and undesired spillage of tube contents. Tubes 104 can be displaced by an operator during removal of cap(s) 112 or otherwise through standard operator handling. Further, in existing tube frames, it may be difficult to access the sealing strip 108 including the caps 112. Accordingly, improved holding methods, tube frame apparatus, tube frame adapters, and tube frame assemblies are sought after.

In view of the foregoing difficulties, there is an unmet need to readily secure tubes, such as part of a strip of tubes, within tube frames, such as when being used in sample processing.

In particular, in some embodiments, a tube frame apparatus is provided. The tube frame apparatus comprises a body with a plurality of apertures formed therein and arranged in rows. The apertures are configured to receive strips of tubes with tubes thereof interconnected by connector strips. In order to retain the strip of tubes within the apertures, locking tabs projecting upwardly from a top surface of the body are configured to engage with the strip of tubes. In one embodiment, at least some of the apertures of the tube frame apparatus have a pair of locking tabs configured to interface with a flange on each tube of the strip of tubes.

In an alternative embodiment, the locking tabs projecting from a top surface of the body are configured to engage with the connector strips that interconnect between the respective tubes of the strip of tubes.

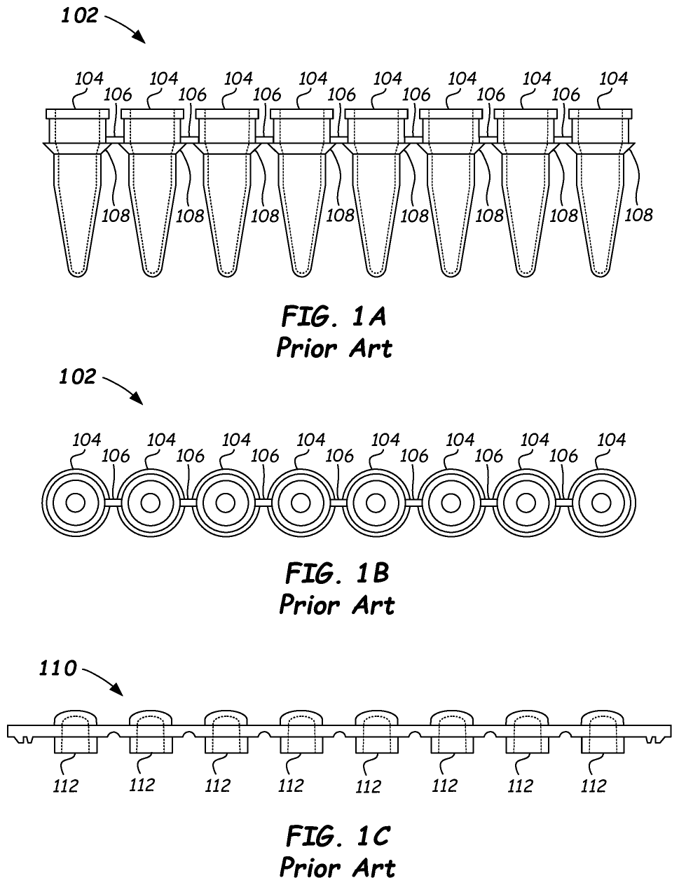

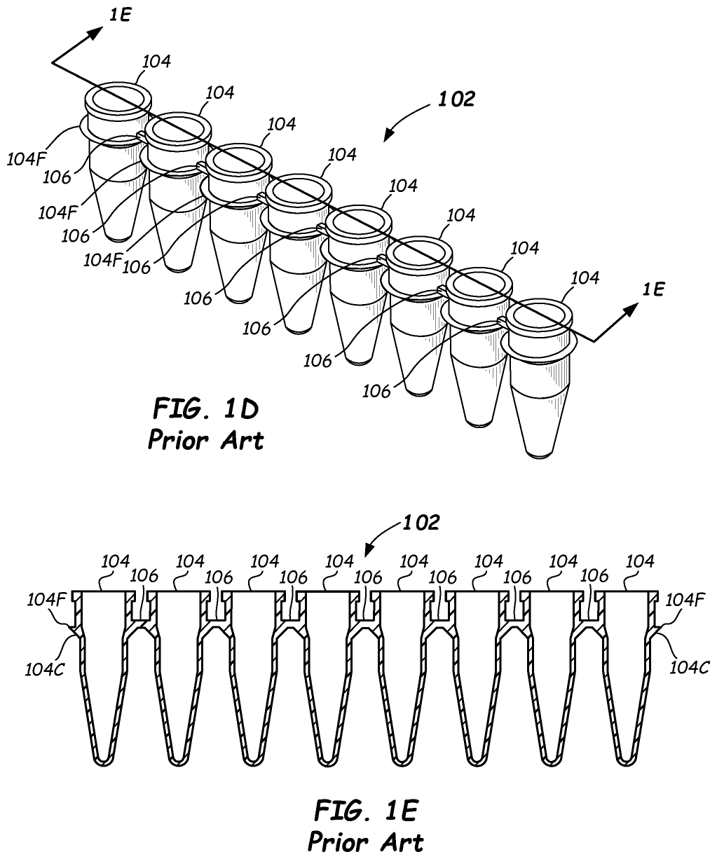

These and other aspects and features of embodiments of the disclosure will be described with reference to FIGS. 1A-7 herein.

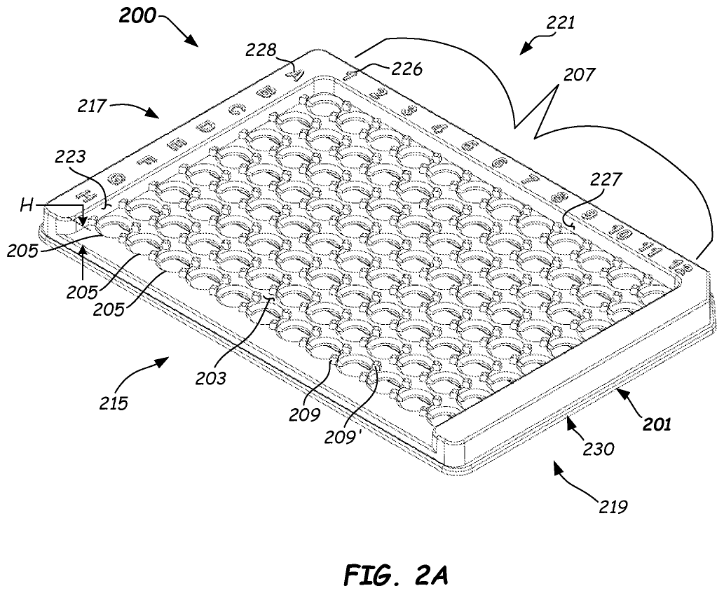

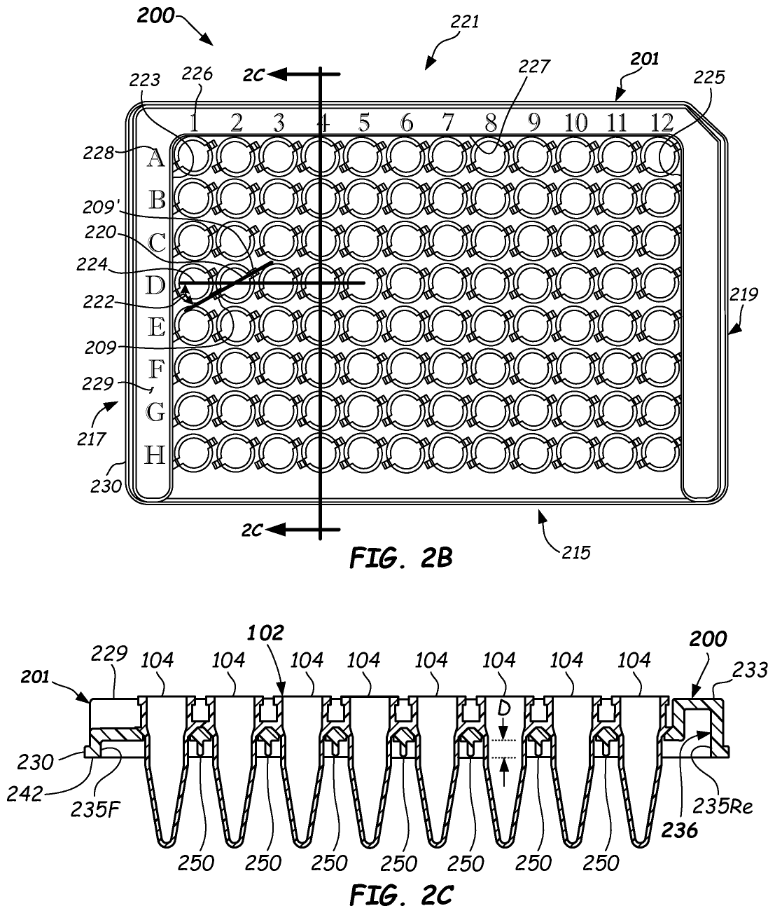

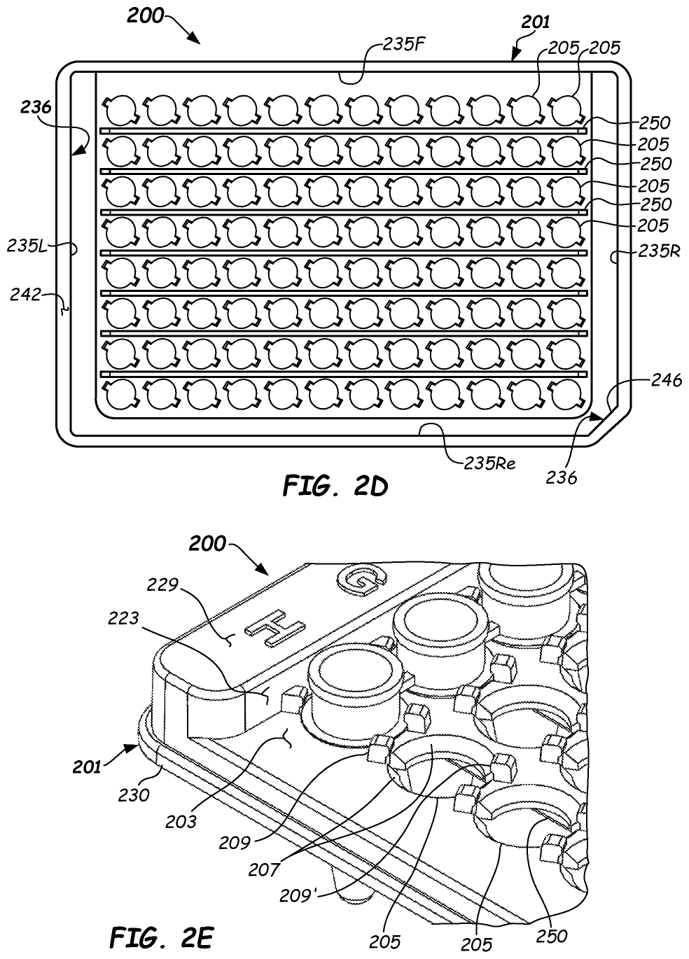

Referring now to FIGS. 2A-2E, an example embodiment of a tube frame apparatus 200 is illustrated. The tube frame apparatus 200 includes a body 201 having a top surface 203. The top surface 203 may be a planar surface, for example. The body 201 includes a plurality of apertures 205 (a few labeled), which can be formed in rows 207 therein. The apertures 205 are configured to receive strips of tubes 102, such as the strip of tubes shown in FIGS. 1A-1C and 1E herein.

The tube frame apparatus 200 may be made of a suitable plastic material, such as a thermoplastic. For example, polycarbonate, polyoxymethylene (POM—also known as acetal), polyacetal, or polyformaldehyde may be used. Optionally, Nylon may be used. Other suitable materials may be used.

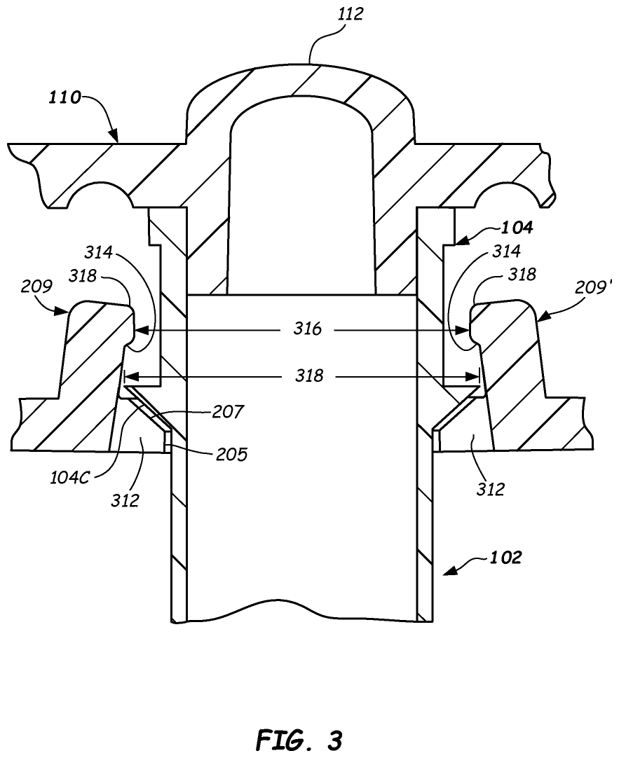

In the depicted embodiment, the plurality of apertures 205 are arranged in twelve rows of eight apertures, for a total of 96 apertures in total for the tube frame apparatus 200. However other numbers of rows, columns, or total number of apertures could be used. The apertures 205 can include, such as shown in FIG. 3E, conical surface portions 207 that are configured to interface with flange portions 104F of each of the tubes 104 that may also include a conical surface 104C formed thereon (FIG. 1D). In this depicted embodiment, the conical surface portions 207 can comprise two conical segments that are positioned in opposition to one another.

In accordance with an aspect of the disclosure, a retaining feature is provided that is configured to engage with the strips of tubes 102. The locking tabs 209, 209′ can include a retaining feature 312 that operates to retain the strip of tubes 102. For example, locking tabs 209, 209′ projecting from the top surface 203 can include this retaining feature. Locking tabs 209, as best shown in FIGS. 2E and 3, can project upwardly from the top surface 203 and are configured to engage with the tubes 104 of the strip of tubes 102 (only one tube shown in FIG. 3) when being inserted in the apertures 205. As can be seen in FIGS. 2A and 2B, there can be two of the locking tabs 209, 209′ on at least some of the plurality of apertures 205, and in the depicted embodiment on all of the apertures 205. In some embodiments, it may be possible to skip locking tabs 209, 209′ on one or more of the apertures 205 and still adequately retain the strip or tubes 102. “Retain” as used herein means that the retaining feature (e.g., the locking tabs 209, 209′) operates as a restriction that provides a retaining force acting on the strip of tubes 102 when trying to remove the strip of tubes 102 from the apertures 205. The retaining force may be provided by an overlapping region of the body 201 positioned above some portion of the strip of tubes 102 that provides an interference to upward motion of the strip of tubes 102 once fully inserted in the apertures 205.

Referring again to FIGS. 2A and 3, the tube frame apparatus 200 can include two of the locking tabs 209, 209′ and they can be diametrically opposed to one another. In the depicted embodiment, there are two of the locking tabs 209, 209′ on each of the plurality of apertures 205. In the embodiment of the tube frame apparatus 200 shown, the locking tabs 209, 209′ are configured to engage with flanges 104F on the tubes 104 of the strips of tubes 102. At least some of the locking tabs 209, 209′ include a retaining feature 314 configured to engage a flange 108 of a tube 104 of the strip of tubes 102 by overhanging the flange 108.

As shown, two conical surface portions 207 can be separated by recesses 312 as best shown in FIG. 3. Recesses 312 may be used during the formation of the locking tabs 209, 209′, such as during a molding process to allow the overhanging features (e.g., the retaining features 312) of the locking tabs 209, 209′ to be formed. In particular, at least some of the locking tabs 209, 209′ include a retaining feature 314. The retaining feature 314 can be a downward facing surface. At least some of the locking tabs 209, 209′ include the recess 314 underneath the retaining feature 314 wherein the retaining feature 312 is downward facing surface.

For example, the retaining feature 314 can be a downward facing lip portion. A minimum inner dimension 316 between innermost portions of the locking tabs 209, 209′ can be manufactured to have a dimension that is less than a corresponding outer dimension (e.g., outer diameter) of the flange 104F. Thus, an overhanging feature is provided so that as the tubes 104 of the strip of tubes 102 are inserted in the apertures 205, at one point, the flanges 104F of the tubes 104 engage and contact the top surface 318 of the locking tabs 209, 209′. As the operator (or robot) further pushes down on the strip of tubes 102, the flanges 104F of the tubes 104, which are formed on a flexible plastic, such as polypropylene (PP), deform and flex so that they can pass (e.g., snap) by the minimum inner dimension 316. Once past the minimum inner dimension 316, the flanges 104F can return to their un-deformed shape, such that the flanges 104F reside underneath the retaining feature 314 and are vertically overlapped thereby.

Thus, as shown, each of the apertures 205 can include at least two locking tabs 209, 209′ and each of the at least two locking tabs 209, 209′ include a retaining feature 314. In some embodiments, more than two locking tabs per aperture 205 can be provided, such as 3, 4, or more. In some embodiments, less than two of the locking tabs may be provided on some of the apertures 205. For example, some may only include one locking tab, or possibly some could include no locking tabs. As shown in FIG. 2A, each of the more than two locking tabs 209, 209′ could include a retaining feature, like retaining feature 314. The retaining feature 314 is said to retain the tubes 104 of the strip of tubes 102 in their respective apertures 205 (i.e., constrain removal thereof) by providing a suitable resistance to the upward movement of the tubes 104 of the strip of tubes 102. The force to remove a respective tube 104 from its corresponding aperture 205 can be designed via the selection of the minimum inner dimension 316 so that any action during processing will not be sufficient to move the flange 104F up past the retaining feature(s) 314.

In order to efficiently place a pair of retaining features on each aperture 205, it may be desirable to offset respective pairs of the locking tabs 209, 209′ relative to the rows and columns so that the apertures 205 can be spaced in close proximity. For example, as best shown in FIG. 2B, the locking tabs 209, 209′on at least some of the plurality of the apertures 205 can comprise a first locking tab 209 and a second locking tab 209′, and wherein a first line 220 extending through respective centers of the first locking tab 209 and the second locking tab 209′ is arranged at an offset angle 222 from a second line 224 connecting respective centerlines of apertures 205 of a row (e.g., row D as shown). Rows are numbered A-H. Columns are numbered as 1 through 12. Offset angle 222 may range between 30 degrees and 40 degrees, for example, to minimize spacing.

In more detail, features of the construction of the tube frame apparatus 200 will now be described. The body 201 of the tube frame apparatus 200 can comprise sides, such as front side 215, left side 217, right side 219, and rear side 221. In the depicted embodiment, the tube frame apparatus 200 can include raised peripheral side walls, but wherein at least one side that is an unraised relative to the top surface 203. For example, as shown, the front side 215 is the one side that is an unraised relative to the top surface 203. The other three sides (e.g., left side 217, right side 219, and rear side 221) include side walls that can be raised a height H above the top surface 203. The raised height H may be between 2 mm and 5 mm, or even between 3.5 mm and 4 mm, for example. Other suitable height H dimensions may be used. Thus, the raised side walls can comprise two lateral side walls (left side wall 223 and right side wall 225), a rear side wall 227, and a front side that is the side that is unraised relative to the top surface 203, i.e., that is devoid of a side wall that is raised above the top surface 203. The unraised side allows ready access to the end of the sealing strip 110 for ease of cap 112 removal.

The raised side walls 223, 225, 227 may be contiguous with, or transition to, raised surfaces, such as left raised surface 229, right raised surface 231, and rear raised surface 233. The raised surfaces may be coplanar with one another and may include column identifiers 226 and row identifiers 228 provided thereon. The column and row identifiers 226, 228 may be embossed, molded, printed, adhered, or otherwise configured thereon.

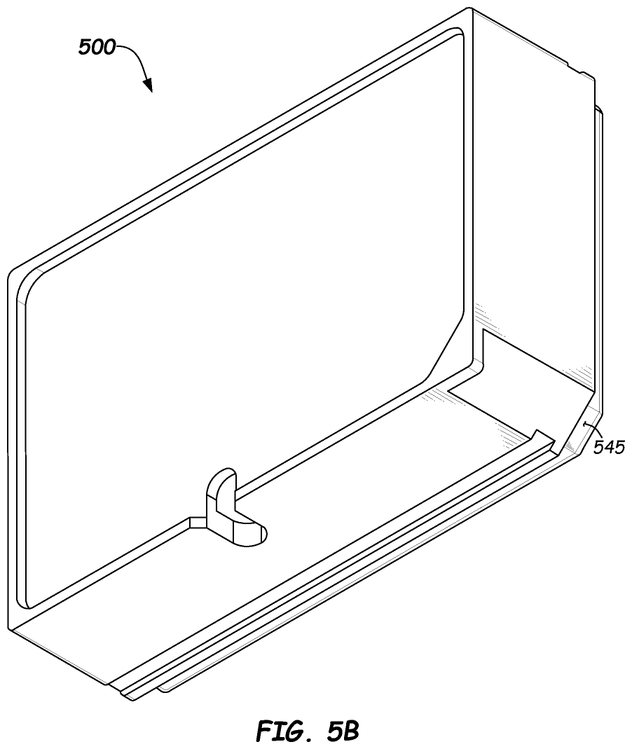

In some embodiments, the body 201 of the tube frame apparatus 200 can include a laterally projecting lip 230 on one or more of the front side 215, left side 217, right side 219, or rear side 221. As shown in FIGS. 2B and 2C, the laterally projecting lip 230 can project from a lower portion of the body 201 and can extend entirely around the perimeter of the body 201. The laterally projecting lip 230 can increase the contact surface area with a tube frame adapter 500 (see FIG. 5A-5B).

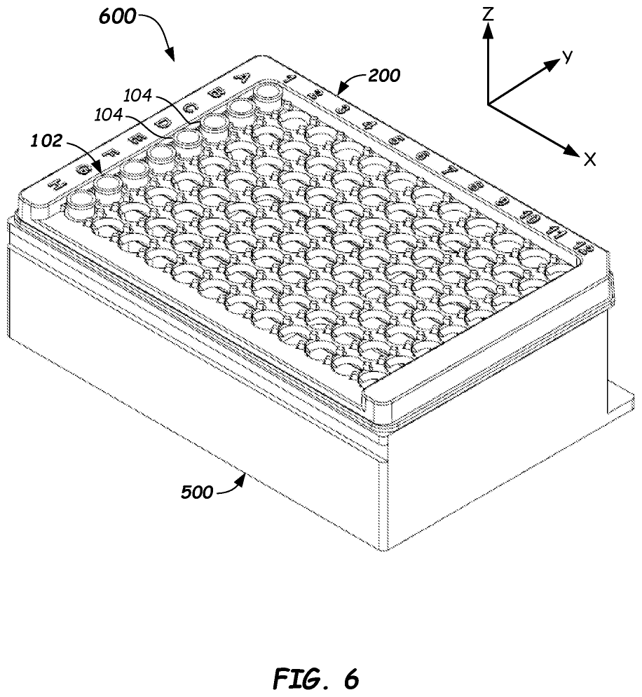

Tube frame apparatus 200 and tube frame adapter 500 shown in FIG. 5A-5B) assemble together and form a tube frame assembly 600 (FIG. 6). This tube frame assembly 600 may be configured to mount on, or to, a moveable tray of a diagnostic analyzer (not shown), for example. As is shown in FIG. 6, the tube frame apparatus 200 mounts to, and registers on, the tube frame adapter 500. In particular, any suitable registration feature may be used wherein the relative motion in the X and Y directions (FIG. 6) are constrained within a desired tolerance, such as +/−1 mm or less, for example. Proper positioning of the tube frame apparatus 200 relative to the diagnostic analyzer (not shown) is desired to ensure that the pipette thereof can be properly oriented relative to the tubes 104.

As shown in FIG. 2C, undercuts 235F, 235Re, 235L, 235R may be formed on the underside of the body 201 (in the Y direction shown and also in the X direction) such that a pocket is formed that can comprise a bottom registration feature 236. The bottom registration feature 236 of the tube frame apparatus 200 is configured to mate with a top registration feature 536 of the tube frame adapter 500. Top registration feature 536, as shown in one embodiment of FIG. 6, can be a series of raised ridges (e.g., left ridge 238, right ridge 239, rear ridge 240 that include respective surfaces (e.g., outer surfaces) that can interface with the undercuts 235 to constrain the X and Y motion within designed limits.

An underside surface 242 of the tube frame apparatus 200 rests on the support surface 544 of the tube frame adapter 500. In some embodiments, the bottom registration feature 236 can include as part thereof or ancillary thereto an anti-reversal feature 245. For example, the anti-reversal feature 245 can function to allow the tube frame apparatus 200 to come fully to rest on the support surface 544 of the tube frame adapter 500 only when the tube frame apparatus 200 is oriented in a designed orientation relative to the tube frame adapter 500. For example, anti-reversal feature 245 will not allow the tube frame apparatus 200 to drop onto the tube frame adapter 500 unless the right ridge 539 is provided directly alongside of the right undercut 235R. In this way, the tube frame apparatus 200 is always properly oriented relative to the tube frame adapter 500. As shown in FIG. 5B, the tube frame adapter 500 can also include an anti-reversal feature that is configured to interface with a plate, platen, or platform of the diagnostic analyzer. The plate, platen, or platform of the diagnostic analyzer may be moveable to load the tube frame assembly 600 into a desirable position in the diagnostic analyzer.

As is shown in FIG. 2D, the anti-reversal feature 245 can comprises a chamfered corner 246 formed on the underside of the body 201. This chamfered corner 246 can interface with a second anti-reversal feature 545 formed on a top side of the tube frame adapter 500 (FIG. 5A). Thus, the tube frame apparatus 200 can be received on the tube frame adapter 500 in only one orientation.

Again referring to FIG. 2D, strengthening features can be added to the underside of the tube frame apparatus 200. For example, the body 201 can comprises a plurality of ribs 250 (a few labeled) formed on the body underside. The ribs 250 can be located between at least some of the plurality of apertures 205 in at least some of the rows. Optionally or additionally, ribs like ribs 250 may be located between at least some of the plurality of apertures 205 in at least some of the columns. Ribs 250 may take on any shape in cross section, such as shown in FIG. 2C and may have a vertical depth of between 0.5 mm and 2 mm, or even between 1 mm and 1.5 mm, from the underside of the body 201. As shown, the body 201 comprises a rib 250 formed between each of the plurality of apertures 205 in each of the rows. Also, each of the plurality of apertures 205 are identical to one another in the depicted embodiment.

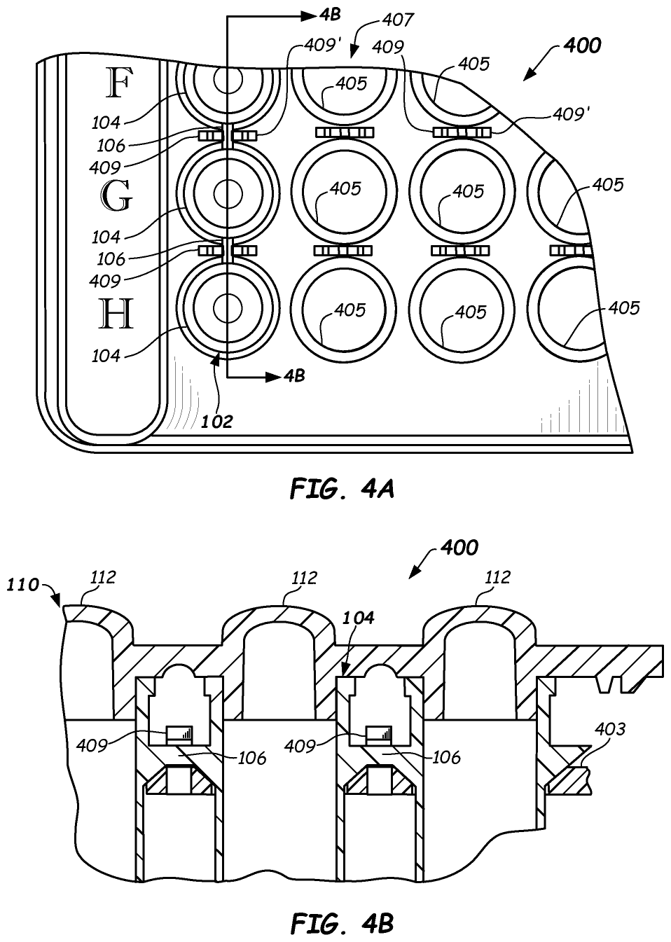

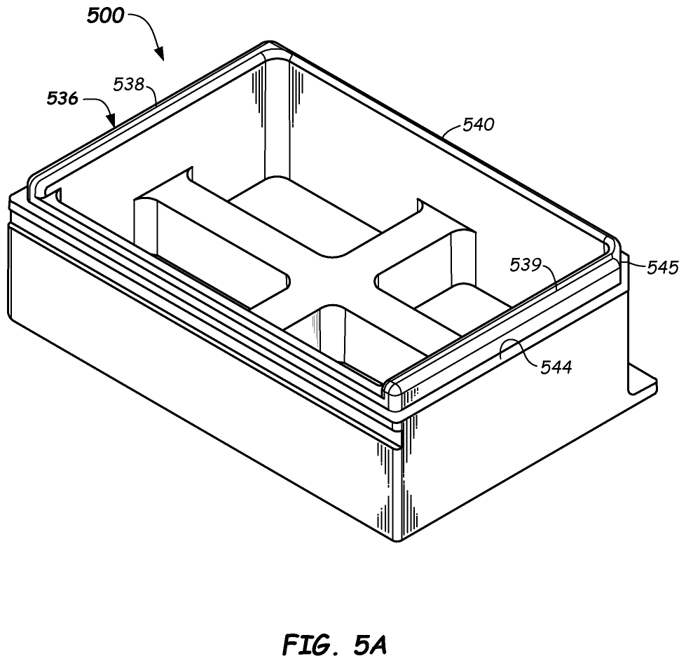

In another embodiment shown in FIGS. 4A and 4B, a tube frame apparatus 400 is provided wherein locking tabs 409, 409′ projecting from the top surface 403 are configured to engage with a connector strip 106 that connects between tubes 104 of the strips of tubes 102. The shape of the locking tabs 409, 409′ can be the same as described for the locking tabs 209, 209′, for example. There can be a pair of locking tabs 409, 409′ associated with each connector strip 106, although in some embodiments they could be provided on less than all and still adequately retain the strip of tubes 102.

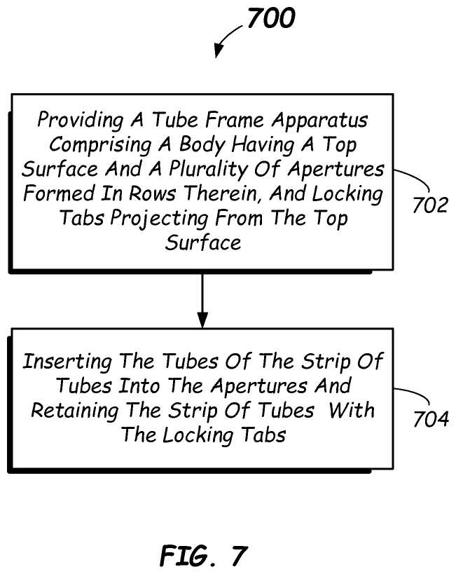

Referring now to FIG. 7, a broad method of holding as strip of tubes (e.g., strip of tubes 102) in a tube frame apparatus (e.g., tube frame apparatus 200) according to one or more embodiments of the disclosure is illustrated. The method 700 includes, in 702, providing a tube frame apparatus (e.g., tube frame apparatus 200) comprising a body (e.g., body 201) having a top surface (e.g., top surface 203, 403) and a plurality of apertures (E.g., plurality of apertures 205, 405) formed in rows (e.g., rows 207, 407), and locking tabs (e.g., locking tabs 209, 209′, 409, 409′) projecting from the top surface.

The method 700 further includes, in 704, inserting the tubes (e.g., tubes 104) of the strip of tubes (e.g., strip of tubes 102) into the apertures (e.g., apertures 205, 405) and retaining the strip of tubes (e.g., strip of tubes 102) with the locking tabs (e.g., locking tabs 209, 209′, 409, 409′).

In the embodiment shown in FIGS. 2A-3, the retaining of the strip of tubes (e.g., strip of tubes 102) comprises snapping flanges (e.g., flanges 104F) of the tubes (e.g., tubes 104) past retaining features (e.g., retaining features 314) of the locking tabs (e.g., locking tabs 209, 209′). Thus, the strip of tubes 102 are retained by the locking tabs 209, 209′ in that they cannot be easily removed without again snapping the flanges (e.g., flanges 104F) of the tubes (e.g., tubes 104) past the retaining features (e.g., retaining features 314), which requires additional force.

In the embodiment shown in FIGS. 4A-4B, the retaining of the strip of tubes (e.g., strip of tubes 102) comprises snapping the connector strips (e.g., connector strips 106) connecting the tubes (e.g., tubes 104) past retaining features of the locking tabs (e.g., locking tabs 409, 409′). Thus, the strip of tubes 102 are retained by the locking tabs 409, 409′ in that they cannot be easily removed without again snapping the connector strips (e.g., connector strips 106) connecting the tubes (e.g., tubes 104) past the retaining features (e.g., retaining features 314) of the locking tabs 409, 409′.

While the disclosure is susceptible to various modifications and alternative forms, specific apparatus, assembly, and methods embodiments have been shown by way of example in the drawings and are described in detail herein. It should be understood, however, that it is not intended to limit the invention to the particular apparatus, assemblies, or methods disclosed but, to the contrary, the intention is to cover all modifications, equivalents, and alternatives falling within the scope of the claims.

What is claimed is:

1. A tube frame apparatus, comprising:
a body having a top surface and a plurality of apertures formed in rows therein, the apertures configured to receive strips of tubes therein; and
locking tabs projecting from the top surface that are configured to engage with the strips of tubes.

2. The tube frame apparatus of claim 1, comprising two of the locking tabs on at least some of the plurality of apertures.

3. The tube frame apparatus of claim 2, wherein the two of the locking tabs are diametrically opposed to one another.

4. The tube frame apparatus of claim 1, comprising two of the locking tabs on each of the plurality of apertures.

5. The tube frame apparatus of claim 1, wherein the plurality of apertures are arranged in twelve rows of eight apertures.

6. The tube frame apparatus of claim 1, wherein the locking tabs on at least some of the plurality of the apertures comprise a first locking tab and a second locking tab, and wherein a first line extending through the first locking tab and the second locking tab is arranged at an offset rotational angle from a second line connecting centerline of apertures of a row.

7. The tube frame apparatus of claim 1, wherein the locking tabs are configured to engage with flanges on tubes of the strips of tubes.

8. The tube frame apparatus of claim 1, wherein at least some of the locking tabs include a retaining feature configured to engage a flange of a tube of the strip of tubes.

9. The tube frame apparatus of claim 1, wherein locking tabs projecting from the top surface are configured to engage with a connector strip that connects between tubes of the strips of tubes.

10. The tube frame apparatus of claim 1, wherein at least some of the locking tabs include a downward-facing retaining feature.

11. The tube frame apparatus of claim 10, wherein at least some of the locking tabs include a recess underneath the downward-facing retaining feature.

12. The tube frame apparatus of claim 1, wherein each of the apertures includes at least two locking tabs and each of the at least two locking tabs include a retaining feature.

13. The tube frame apparatus of claim 1, wherein the body comprises sides with raised peripheral side walls and at least one side that is an unraised relative to the top surface.

14. The tube frame apparatus of claim 13, wherein the raised peripheral side walls comprise a rear peripheral side wall and two lateral peripheral side walls and a front side that is the side that is unraised relative to the top surface.

15. The tube frame apparatus of claim 1, wherein the body comprises a bottom registration feature.

16. The tube frame apparatus of claim 15, wherein the bottom registration feature further comprises an anti-reversal feature.

17. The tube frame apparatus of claim 16, wherein the anti-reversal feature comprises chamfered corner on the body.

18. The tube frame apparatus of claim 1, wherein the body comprises a plurality of ribs formed on a body underside between at least some of the plurality of apertures in at least some of the rows.

19. The tube frame apparatus of claim 1, wherein the body comprises a rib formed between each of the plurality of apertures in each of the rows.

20. The tube frame apparatus of claim 1, wherein each of the plurality of apertures are identical.

21. A tube frame assembly, comprising:
a tube frame adapter including a top registration feature; and
tube frame apparatus having a body 201 including a bottom registration feature registered on the top registration feature, the body further including a top surface and a plurality of apertures 205 formed in rows therein, the apertures configured to receive strips of tubes therein, and locking tabs projecting from the top surface that are configured to engage with the strips of tubes.

22. A method of holding a strip of tubes, comprising:
providing a tube frame apparatus, comprising a body having a top surface and a plurality of apertures formed in rows, and locking tabs projecting from the top surface; and
inserting tubes of the strip of tubes into the apertures and retaining the strip of tubes with the locking tabs.

23. The method of claim 22, wherein the retaining the strip of tubes comprises snapping flanges of the tubes past retaining features of the locking tabs.

24. The method of claim 22, wherein the retaining the strip of tubes comprises snapping connector strips between the tubes of the strip of tubes past retaining features of the locking tabs.
